(19) United States
(12) Patent Application Publication
(10) Pub. No.: US 2023/0396304 A1
(43) Pub. Date: Dec. 7, 2023

(54) NEW BEAM INDICATION REPORTING FOR MULTI-BEAM OPERATION

(71) Applicant: QUALCOMM Incorporated, San Diego, CA (US)

(72) Inventors: Fang YUAN, Beijing (CN); Yan ZHOU, San Diego, CA (US); Wooseok NAM, San Diego, CA (US); Mostafa KHOSHNEVISAN, San Diego, CA (US); Xiaoxia ZHANG, San Diego, CA (US); Tao LUO, San Diego, CA (US)

(21) Appl. No.: 18/249,529

(22) PCT Filed: Dec. 16, 2020
(86) PCT No.: PCT/CN2020/136687

§ 371 Date: Apr. 18, 2023

(51) Int. Cl. H04B 7/06; H04W 74/02

(52) U.S. Cl. CPC H04B 7/0695; H04W 74/02

(57) ABSTRACT

Methods, systems, and devices for wireless communications are described. Generally, the described techniques at a user equipment (UE) provide for indicating multiple beams to a base station for communications with the base station after detecting a beam failure. Using these techniques, the UE may rely on multi-beam operation to recover communications with the base station. The UE may transmit a random-access preamble indicating a first beam for communications with the base station, and the UE may transmit a control element in a data channel indicating a second beam for communications with the base station. In some cases, the messages used to carry the indications of the multiple beams may be based on a type of random-access procedure used to recover communications (e.g., a contention-based random-access (CBRA) procedure, a contention-free random-access (CFRA) procedure, or a two-step random-access procedure).

### CROSS REFERENCE

The present Application is a 371 national stage filing of International PCT Application No. PCT/CN2020/136687 by YUAN et al. entitled “NEW BEAM INDICATION REPORTING FOR MULTI-BEAM OPERATION,” filed Dec. 16, 2020, which is assigned to the assignee hereof, and which is expressly incorporated by reference in its entirety herein.

### FIELD OF TECHNOLOGY

The following relates to wireless communications, including new beam indication reporting for multi-beam operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). In some wireless communications systems, a UE may support communications with a base station using multiple beams. In such systems, the UE may experience beam failure, and the UE may support beam failure recovery techniques to recover communications with the base station. Improved techniques at a UE for recovering communications with a base station may be desirable.

### SUMMARY

The described techniques relate to improved methods, systems, devices, and apparatuses that support new beam indication (NBI) reporting for multi-beam operation. Generally, the described techniques at a user equipment (UE) provide for indicating multiple beams to a base station for communications with the base station after detecting a beam failure. Using these techniques, the UE may rely on multi-beam operation to recover communications with the base station. The UE may transmit a random-access preamble in a random-access occasion indicating a first beam for communications with the base station, and the UE may transmit a control element in a data channel indicating a second beam for communications with the base station. In some cases, the messages used to carry the indications of the multiple beams may be based on a type of random-access procedure used to recover communications (e.g., a contention-based random-access (CBRA) procedure, a contention-free random-access (CFRA) procedure, or a two-step random-access procedure).

### BRIEF DESCRIPTION OF THE DRAWINGS

FIG. 1 illustrates an example of a wireless communications system that supports new beam indication (NBI) reporting for multi-beam operation in accordance with aspects of the present disclosure.

FIG. 2 illustrates an example of a wireless communications system that supports NBI reporting for multi-beam operation in accordance with aspects of the present disclosure.

FIG. 3 illustrates an example of a process flow that supports NBI reporting for multi-beam operation in accordance with aspects of the present disclosure.

FIG. 4 illustrates an example of a process flow that supports NBI reporting for multi-beam operation in accordance with aspects of the present disclosure.

FIG. 5 illustrates an example of a process flow that supports NBI reporting for multi-beam operation in accordance with aspects of the present disclosure.

FIG. 6 illustrates an example of an architecture that supports NBI reporting for multi-beam operation in accordance with aspects of the present disclosure.

FIGS. 7 and 8 show block diagrams of devices that support NBI reporting for multi-beam operation in accordance with aspects of the present disclosure.

FIG. 9 shows a block diagram of a communications manager that supports NBI reporting for multi-beam operation in accordance with aspects of the present disclosure.

FIG. 10 shows a diagram of a system including a device that supports NBI reporting for multi-beam operation in accordance with aspects of the present disclosure.

FIGS. 11 and 12 show block diagrams of devices that support NBI reporting for multi-beam operation in accordance with aspects of the present disclosure.

FIG. 13 shows a block diagram of a communications manager that supports NBI reporting for multi-beam operation in accordance with aspects of the present disclosure.

FIG. 14 shows a diagram of a system including a device that supports NBI reporting for multi-beam operation in accordance with aspects of the present disclosure.

FIGS. 15 and 16 show flowcharts illustrating methods that support NBI reporting for multi-beam operation in accordance with aspects of the present disclosure.

### DETAILED DESCRIPTION

In some wireless communications systems, a UE may support communications with a base station using multiple beams. In such systems, the UE may experience beam failure, and the UE may support beam failure recovery techniques to recover communications with the base station. For instance, the UE may use a random-access procedure to re-establish a connection with the base station. As part of the random-access procedure, the UE may transmit an indication of a single new beam for communications with the base station. The single new beam may replace a previous failed beam and may be used for subsequent communications with the base station. However, if the UE is configured to indicate a single new beam for communications with the base station, the UE may be unable to rely on multi-beam operation to recover communications with the base station. If the UE fails to recover communications with the base station, the UE may experience reduced throughput, and user experience may be degraded.

As described herein, a UE may support efficient techniques for indicating multiple beams to a base station for communications with the base station after detecting a beam failure. The UE may transmit a random-access preamble in a random-access occasion indicating a first beam for communications with the base station, and the UE may transmit a control element in a data channel indicating a second beam for communications with the base station. In some cases, the messages used to carry the indications of the multiple beams may be based on a type of random-access procedure used to recover communications (e.g., a contention-based random-access (CBRA) procedure, a contention-free random-access (CFRA) procedure, or a two-step random-access procedure).

Using the techniques described herein, a UE may rely on multi-beam operation to recover communications with a base station. For instance, the UE may monitor for control information used to recover communications with the base station using multiple beams, and, as a result, the UE may be more likely to receive the control information from the base station and recover communications with the base station.

Aspects of the disclosure introduced above are described below in the context of a wireless communications system. Examples of processes and signaling exchanges that support new beam indication (NBI) reporting for multi-beam operation are then described. Aspects of the disclosure are further illustrated by and described with reference to apparatus diagrams, system diagrams, and flowcharts that relate to NBI reporting for multi-beam operation.

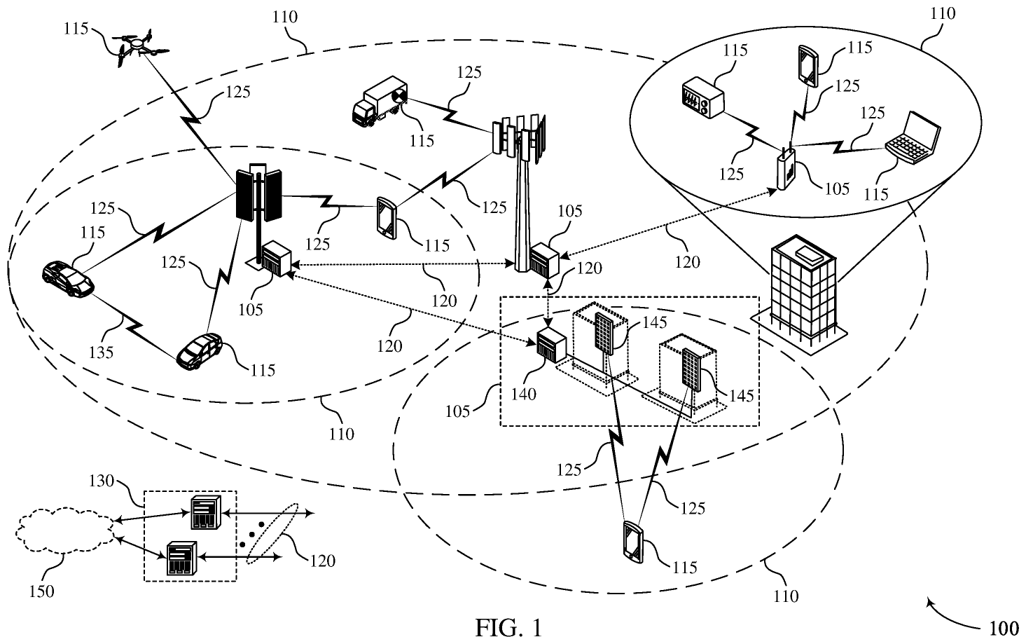

FIG. 1 illustrates an example of a wireless communications system 100 that supports NBI reporting for multi-beam operation in accordance with aspects of the present disclosure. The wireless communications system 100 may include one or more base stations 105, one or more UEs 115, and a core network 130. In some examples, the wireless communications system 100 may be a Long-Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105 (e.g., in a physical uplink control channel (PUCCH) or a physical uplink shared channel (PUSCH)), or downlink transmissions from a base station 105 to a UE 115 (e.g., in a physical downlink control channel (PDCCH) or a physical downlink shared channel (PDSCH)). Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of T_{S}=1/(Δƒₘₐₓ·N_{ƒ}) seconds, where Δƒₘₐₓ may represent the maximum supported subcarrier spacing, and N_{ƒ} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

In wireless communications system 100, a UE 115 may support communications with a base station 105 using multiple beams. In some cases, the UE 115 may experience beam failure, and the UE 115 may support beam failure recovery (BFR) techniques to recover communications with the base station 105. For instance, the UE may use a random-access procedure to re-establish a connection with the base station 105. The random-access procedure may also be referred to as a random-access channel (RACH) procedure or a physical RACH (PRACH) procedure. As part of the random-access procedure, the UE 115 may transmit an indication of a single new beam for communications with the base station 105. An indication of a beam may be a channel state information reference signal (CSI-RS) resource index or synchronization signal block (SSB) or physical broadcast channel (PBCH) index associated with the beam. The single new beam may replace a previous failed beam and may be used for subsequent communications with the base station 105.

As an example, for each bandwidth part (BWP) of a serving cell, the UE 115 may be provided with a set q0 of periodic CSI-RS resource configuration indexes (e.g., by a failureDetectionResources parameter) and a set q1 of periodic CSI-RS resource configuration indexes and/or SSB/PBCH block indexes for radio link quality measurements on the BWP of the serving cell. The UE 115 may also receive (e.g., by a PRACH-ResourceDedicatedBFR parameter) a configuration for PRACH transmission. For a PRACH transmission in a slot n and according to antenna port quasi co-location parameters associated with a periodic CSI-RS resource configuration or with an SSB or PBCH associated with index new q provided by higher layers, the UE 115 may monitor PDCCH in a search space set (e.g., provided by a recoverySearchSpaceId parameter) for detection of a downlink control information (DCI) format with cyclic redundancy check (CRC) scrambled by a cell radio network temporary identifier (C-RNTI) or modulation and coding scheme (MCS)C-RNTI starting from slot n+4 within a window (e.g., configured by a BeamFailureRecoveryConfig parameter).

In the example described above, to recover communications with a base station 105, the UE 115 may monitor a PDCCH using a single new beam selected for subsequent communications with the base station 105. In some cases, a PDCCH transmission may be associated with two beams (e.g., two transmission configuration indication (TCI) states). In one aspect, one CORESET may be associated with two active TCI states, and the PDCCH transmission may be transmitted with two TCI states in the CORESET. In another aspect, each CORESET may be associated with one TCI state, one search space may be associated with two different CORESETs, and the PDCCH transmission may be transmitted with two TCI states in the two different CORESETs. In yet another aspect, each CORESET may be associated with one TCI state, two search spaces may be associated with corresponding CORESETs (i.e., two different CORESETs), and the PDCCH transmission may be transmitted with two TCI states in the two different CORESETs. Thus, a base station 105 may be capable of transmitting control information in a PDCCH using multiple beams to recover communications with a UE 115.

In some cases, however, because the UE 115 may indicate a single new beam for communications with the base station 105, the UE 115 may be unable to rely on multi-beam operation to recover communications with the base station 105. If the UE 115 fails to recover communications with the base station 105, the UE 115 may experience reduced throughput, and user experience may be degraded. As described herein, a UE 115 in wireless communications system 100 may support efficient techniques for indicating multiple beams to a base station 105 for communications with the base station 105 after detecting a beam failure. Using these techniques, the UE 115 may be able to rely on multi-beam operation to recover communications with the base station 105. That is, the UE 115 may monitor for detection of DCI in a PDCCH on multiple beams.

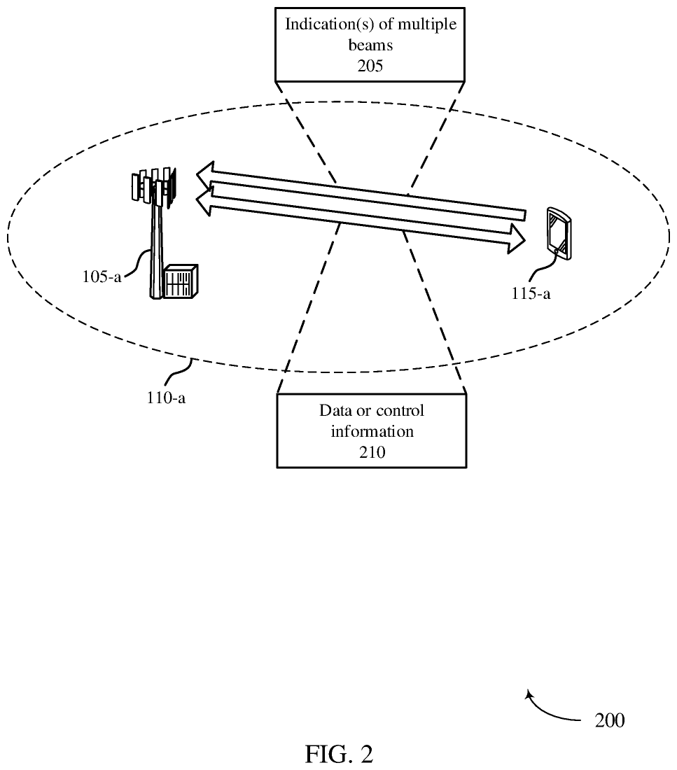

FIG. 2 illustrates an example of a wireless communications system 200 that supports NBI reporting for multi-beam operation in accordance with aspects of the present disclosure. The wireless communications system 200 includes a UE 115-a, which may be an example of a UE 115 described with reference to FIG. 1. The wireless communications system 200 also includes a base station 105-a, which may be an example of a base station 105 described with reference to FIG. 1. The base station 105-a may provide communication coverage for a coverage area 110-a. The wireless communications system 200 may implement aspects of wireless communications system 100. For example, the UE 115-a in wireless communications system 200 may support efficient techniques for indicating multiple beams to the base station 105-a for communications with the base station 105-a after detecting a beam failure.

The UE 115-a may transmit multiple indications 205 to the base station 105-a of multiple beams for communications with the base station 105-a. In particular, the UE 115-a may transmit an indication of a first beam for communications with the base station 105-a and an indication of at least a second beam for communications with the base station 105-a. The indication of the first beam may be a random-access preamble in a random-access occasion corresponding to the first beam, and the indication of the second beam may be included in a control element in a data channel. An indication of a new beam for communications with the base station 105-a may be referred to as an NBI and may be mapped to or may be in the form of a CSI-RS resource index or SSB index associated with the beam. Using these techniques, the UE 115-a may rely on multi-beam operation to recover communications with the base station 105-a. That is, the UE 115-a may exchange data or control information 210 with the base station 105-a on multiple beams.

In some cases, the messages used to carry the indications 205 of the multiple beams may be based on a type of random-access procedure used to recover communications (e.g., a CBRA procedure, a CFRA procedure, or a two-step random-access procedure).

In one example, as part of a CBRA procedure, the UE 115-a may transmit a first RACH message including a random-access preamble in a random-access occasion (i.e., random-access preamble transmission occasion) indicating a first beam for communications with the base station 105-a. The beam index of the first beam may have a one-to-one mapping to the random-access occasion, and multiple random-access occasions may be in different time and frequency domains and may be associated with different preambles. The UE 115-a may then receive a random-access response (RAR) scheduling a PUSCH transmission in a third RACH message, and the UE 115-a may transmit the third RACH message including a control element in the PUSCH indicating a second beam for communications with the base station 105-a.

In another example, as part of a CFRA procedure, the UE 115-a may transmit a first RACH message including a random-access preamble in a random-access occasion indicating a first beam for communications with the base station 105-a. The beam index of the first beam may have a one-to-one mapping to the random-access occasion, and multiple random-access occasions may be in different time and frequency domains and may be associated with different preambles. The UE 115-a may then receive a beam failure response scheduling a PUSCH transmission, and the UE 115-a may transmit a control element in the PUSCH indicating a second beam for communications with the base station 105-a.

In yet another example, as part of a two-step random-access procedure, the UE 115-a may transmit a first RACH message including a random-access preamble in a random-access occasion indicating a first beam for communications with the base station 105-a and a control element in a PUSCH indicating a second beam for communications with the base station 105-a. The beam index of the first beam may have a one-to-one mapping to the random-access occasion, and multiple random-access occasions may be in different time and frequency domains and may be associated with different preambles.

In some cases, the UE 115-a may be enabled with multiple transmission and reception (TRP) panels for communications with the base station 105-a (e.g., communications using the multiple beams on multiple TRP panels). In such cases, a first beam indicated to the base station 105-a for communications with the base station 105 may be associated with a first TRP panel at the UE 115-a, a second beam indicated to the base station 105-a for communications with the base station 105 may be associated with a second TRP panel, and so forth. As such, in addition to indicating a beam for communications with the base station 105-a, the UE 115-a may indicate a TRP panel associated with the indicated beam. In one example, an ID of a panel associated with a beam indicated to the base station 105-a in a control element (e.g., MAC control element (MAC-CE)) may be explicitly carried in the control element. The base station 105 may then be able to schedule communications with the UE 115-a on an appropriate panel using a beam associated with (e.g., generated by) that panel.

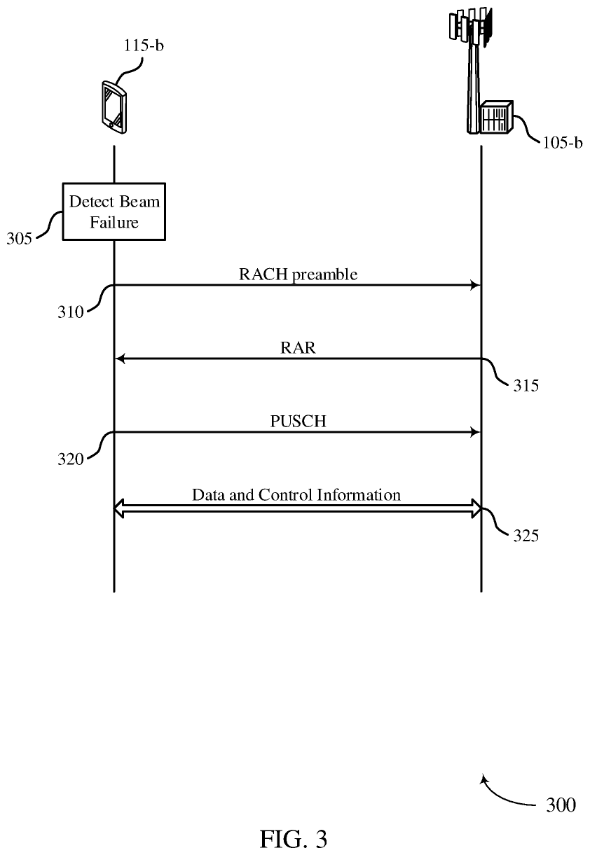

FIG. 3 illustrates an example of a process flow 300 that supports NBI reporting for multi-beam operation in accordance with aspects of the present disclosure. Process flow 300 illustrates aspects of techniques performed by a UE 115-b, which may be an example of a UE 115 described with reference to FIGS. 1-2. Process flow 300 also illustrates aspects of techniques performed by a base station 105-b, which may be an example of a base station 105 described with reference to FIGS. 1-2. Process flow 300 may implement aspects of wireless communications system 200. For example, the UE 115-b in process flow 300 may support efficient techniques for indicating multiple beams to the base station 105-b for communications with the base station 105-b after detecting a beam failure.

In the following description of the process flow 300, the operations between the UE 115-b and the base station 105-b may be transmitted in a different order than the example order shown, or the operations performed by the base station 105-b and the UE 115-b may be performed in different orders or at different times. Some operations may also be omitted from the process flow 300, and other operations may be added to the process flow 300.

At 305, while communicating with the base station 105-b using one or more beams, the UE 115-b may detect beam failure. The UE 115-b may detect beam failure after one or more instances where the UE 115-b fails to receive reference signals from the base station 105-b or a power or quality of reference signals received from the base station 105-b is below a threshold. Such reference signals may be referred to as beam failure detection reference signals. After beam failure is detected, the UE 115-b may trigger beam failure recovery by initiating a random-access procedure with the base station 105-b.

In the example of FIG. 3, the UE 115-b may initiate a CBRA procedure. In the CBRA procedure, the UE 115-b may randomly select a RACH preamble to transmit to the base station 105-b from a set of RACH preambles. Because the UE 115-b may select the RACH preamble randomly, there may be a chance that another UE 115 selects the same RACH preamble as the UE 115-b, resulting in PRACH collision which may be referred to as contention. As described herein, for a beam failure recovery procedure based on CBRA, the UE 115-b may report multiple NBIs corresponding to multiple beams for communications with the base station 105-b.

As part of the CBRA procedure, at 310, the UE 115-b may transmit a first RACH message (e.g., Msg1) to the base station 105-b including the RACH preamble in a RACH occasion. The RACH preamble in the RACH occasion may indicate a first beam for communications with the base station 105-b. That is, a first NBI may be indicated by the RACH preamble, the RACH occasion, or both. The RACH occasion may refer to time and frequency resources used to transmit the RACH preamble, and different RACH preambles (e.g., sequences), different RACH occasions, or different combinations of RACH preambles and RACH occasions may map to different beams. Thus, when the UE 115-b identifies the first beam (e.g., first new beam) for communications with the base station 105-b, the UE 115-b may transmit a RACH preamble in a RACH occasion that maps to the first beam. The base station 105-b may then receive the RACH preamble in the RACH occasion and determine that the RACH preamble in the RACH occasion maps to the first beam. Thus, the base station 105-b may determine that the UE 115-b has indicated the first beam for communications with the base station 105-b.

At 315, the base station 105-b may transmit, and the UE 115-b may receive, a second RACH message (e.g., Msg2) including a RAR in response to the RACH preamble. In some cases, the first beam indicated by the RACH preamble in the RACH occasion at 310 may be used as the default beam for subsequent messages (e.g., Msg2 and afterwards). That is, the base station 105-b may transmit, and the UE 115-b may receive, the second RACH message using the first beam. The RAR may schedule a PUSCH transmission from the UE 115-b in a third RACH message. Specifically, the RAR may include DCI (e.g., uplink DCI) scrambled by a random-access radio network temporary identifier (RA-RNTI), and the DCI may schedule the PUSCH transmission.

At 320, the UE 115-b may transmit, and the base station 105-b may receive, a third RACH message (e.g., Msg3) including a PUSCH (i.e., the scheduled PUSCH transmission). The PUSCH may include a control element (e.g., MAC-CE) indicating at least a second beam for communications with the base station 105-b. That is, the control element in the PUSCH may indicate one or more additional beams (e.g., remaining NBIs) for communications with the base station 105-b. In some cases, the first beam indicated by the RACH preamble in the RACH occasion at 310 may also be used for the third RACH message. That is, the UE 115-b may transmit, and the base station 105-b may receive, the third RACH message using the first beam.

In some cases, in addition to indicating the first beam and the second beam to the base station 105-b, the UE 115-b may indicate a TRP panel associated with the first beam, a TRP panel associated with the second beam, or both. In such cases, the first beam may be associated with a first TRP panel and the second beam may be associated with a second TRP panel. In one example, the UE 115-b may transmit an indication of the second TRP panel associated with the second beam in the control element in the PUSCH at 320 (e.g., the same control element that carries the indication of the second beam). That is, the ID of the second TRP panel may be explicitly carried in the control element (e.g., MAC-CE). As an example, the ID of a TRP panel may be zero or one, where zero indicates the first TRP panel and one indicates the second TRP panel. The base station 105-b may then schedule communications with the UE 115-b on a beam based at least in part on a TRP panel associated with the beam.

At 325, the UE 115-b and the base station 105-b may communicate using the first beam, the second beam, or both. For instance, after indicating the first beam and the second beam to the base station 105-b, the UE 115-b may monitor a PDCCH for control information from the base station 105-b using the first beam and the second beam to recover communications with the base station 105-b. That is, the UE 115-b may rely on multi-beam operation to recover communications with the base station 105-b.

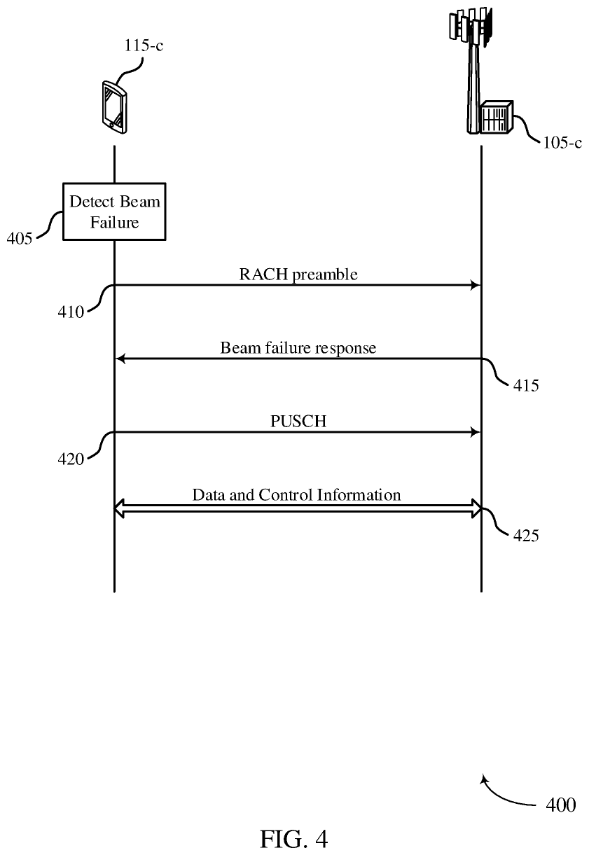

FIG. 4 illustrates an example of a process flow 400 that supports NBI reporting for multi-beam operation in accordance with aspects of the present disclosure. Process flow 400 illustrates aspects of techniques performed by a UE 115-c, which may be an example of a UE 115 described with reference to FIGS. 1-3. Process flow 400 also illustrates aspects of techniques performed by a base station 105-c, which may be an example of a base station 105 described with reference to FIGS. 1-3. Process flow 400 may implement aspects of wireless communications system 200. For example, the UE 115-c in process flow 400 may support efficient techniques for indicating multiple beams to the base station 105-c for communications with the base station 105-c after detecting a beam failure.

In the following description of the process flow 400, the operations between the UE 115-c and the base station 105-c may be transmitted in a different order than the example order shown, or the operations performed by the base station 105-c and the UE 115-c may be performed in different orders or at different times. Some operations may also be omitted from the process flow 400, and other operations may be added to the process flow 400.

At 405, while communicating with the base station 105-c using one or more beams, the UE 115-c may detect beam failure. The UE 115-c may detect beam failure after one or more instances where the UE 115-c fails to receive reference signals from the base station 105-c or a power or quality of reference signals received from the base station 105-c is below a threshold. Such reference signals may be referred to as beam failure detection reference signals. After beam failure is detected, the UE 115-c may trigger beam failure recovery by initiating a random-access procedure with the base station 105-c.

In the example of FIG. 4, the UE 115-c may initiate a CFRA procedure. In the CFRA procedure, the UE 115-c may receive an indication from the base station 105-c of a RACH preamble to use in a RACH procedure. Because the RACH preamble may not be selected by another UE 115, there may be no contention between the UE 115-c and another UE 115. That is, there may be no PRACH collision and, as a result, there may be no contention. As described herein, for a beam failure recovery procedure based on CFRA, the UE 115-c may report multiple NBIs corresponding to multiple beams for communications with the base station 105-c.

As part of the CFRA procedure, at 410, the UE 115-c may transmit a first RACH message (e.g., Msg1) to the base station 105-c including the RACH preamble in a RACH occasion. The RACH preamble in the RACH occasion may indicate a first beam for communications with the base station 105-c. That is, a first NBI may be indicated by the RACH preamble, the RACH occasion, or both. The RACH occasion may refer to time and frequency resources used to transmit the RACH preamble, and different RACH preambles (e.g., sequences), different RACH occasions, or different combinations of RACH preambles and RACH occasions may map to different beams. Thus, when the UE 115-c identifies the first beam (e.g., first new beam) for communications with the base station 105-c, the UE 115-c may transmit a RACH preamble in a RACH occasion that maps to the first beam. The base station 105-c may then receive the RACH preamble in the RACH occasion and determine that the RACH preamble in the RACH occasion maps to the first beam. Thus, the base station 105-c may determine that the UE 115-c has indicated the first beam for communications with the base station 105-c.

In some aspects, in addition to or as an alternative to transmitting the RACH preamble in the RACH occasion, the UE 115-c may transmit a first scheduling request (SR) message to the base station 105-c in an SR occasion. The SR occasion (e.g., dedicated SR occasion) may indicate the first beam for communications with the base station 105-c. That is, each NBI (or NBI value) of a plurality of NBIs (or NBI values) may be mapped to a different SR occasion, and a first NBI associated with the first beam may be indicated by a dedicated SR occasion used to transmit an SR. The SR occasion may refer to time and frequency resources used to transmit the SR, and different SR occasions may map to different beams (e.g., NBIs).

At 415, the base station 105-c may transmit, and the UE 115-c may receive, a second RACH message (e.g., Msg2) including a beam failure response in response to the RACH preamble. In some cases, the first beam indicated by the RACH preamble in the RACH occasion at 410 may be used as the default beam for subsequent messages (e.g., the beam failure response and afterwards). That is, the base station 105-c may transmit, and the UE 115-c may receive, the second RACH message using the first beam. The beam failure response may schedule a PUSCH transmission from the UE 115-c. Specifically, the beam failure response may include DCI (e.g., uplink DCI) scrambled by a C-RNTI, and the DCI may schedule the PUSCH transmission. In some cases, the base station 105-c may transmit, and the UE 115-c may receive, the beam failure response in a search space and a CORESET dedicated to beam failure recovery.

At 420, the UE 115-c may transmit, and the base station 105-c may receive, the PUSCH transmission. The PUSCH may include a control element (e.g., MAC-CE) indicating at least a second beam for communications with the base station 105-c. That is, the control element in the PUSCH may indicate one or more additional beams (e.g., remaining NBIs) for communications with the base station 105-c. In some cases, the first beam indicated by the RACH preamble in the RACH occasion at 410 may also be used for the PUSCH transmission. That is, the UE 115-c may transmit, and the base station 105-c may receive, the PUSCH transmission using the first beam.

In some cases, in addition to indicating the first beam and the second beam to the base station 105-c, the UE 115-c may indicate a TRP panel associated with the first beam, a TRP panel associated with the second beam, or both. In such cases, the first beam may be associated with a first TRP panel and the second beam may be associated with a second TRP panel. In one example, the UE 115-c may transmit an indication of the second TRP panel associated with the second beam in the control element in the PUSCH at 420 (e.g., the same control element that carries the indication of the second beam). That is, the ID of the second TRP panel may be explicitly carried in the control element (e.g., MAC-CE). The base station 105-c may then schedule communications with the UE 115-c on a beam based at least in part on a TRP panel associated with the beam.

At 425, the UE 115-c and the base station 105-c may communicate using the first beam, the second beam, or both. For instance, after indicating the first beam and the second beam to the base station 105-c, the UE 115-c may monitor a PDCCH for control information from the base station 105-c using the first beam and the second beam to recover communications with the base station 105-c. That is, the UE 115-c may rely on multi-beam operation to recover communications with the base station 105-c.

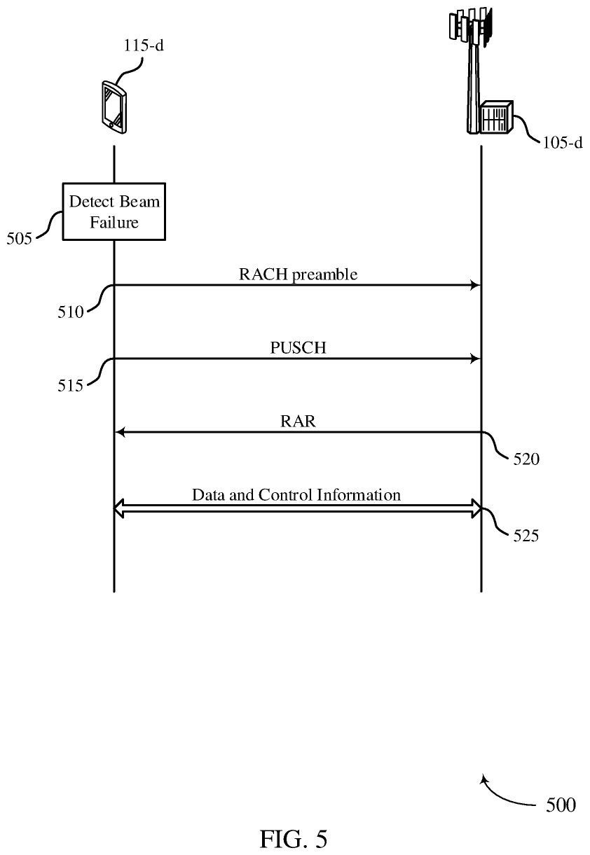

FIG. 5 illustrates an example of a process flow 500 that supports NBI reporting for multi-beam operation in accordance with aspects of the present disclosure. Process flow 500 illustrates aspects of techniques performed by a UE 115-d, which may be an example of a UE 115 described with reference to FIGS. 1-4. Process flow 500 also illustrates aspects of techniques performed by a base station 105-d, which may be an example of a base station 105 described with reference to FIGS. 1-4. Process flow 500 may implement aspects of wireless communications system 200. For example, the UE 115-d in process flow 500 may support efficient techniques for indicating multiple beams to the base station 105-d for communications with the base station 105-d after detecting a beam failure.

In the following description of the process flow 500, the operations between the UE 115-d and the base station 105-d may be transmitted in a different order than the example order shown, or the operations performed by the base station 105-d and the UE 115-d may be performed in different orders or at different times. Some operations may also be omitted from the process flow 500, and other operations may be added to the process flow 500.

At 505, while communicating with the base station 105-d using one or more beams, the UE 115-d may detect beam failure. The UE 115-d may detect beam failure after one or more instances where the UE 115-d fails to receive reference signals from the base station 105-d or a power or quality of reference signals received from the base station 105-d is below a threshold. Such reference signals may be referred to as beam failure detection reference signals. After beam failure is detected, the UE 115-d may trigger beam failure recovery by initiating a random-access procedure with the base station 105-d.

In the example of FIG. 4, the UE 115-d may initiate a two-step random-access procedure. As described herein, for a beam failure recovery procedure based on two-step random-access, the UE 115-d may report multiple NBIs corresponding to multiple beams for communications with the base station 105-d. As part of the two-step random-access procedure, the UE 115-d may transmit a first RACH message (e.g., MsgA) to the base station 105-d. The first RACH message may include the RACH preamble at 510 and the PUSCH at 515. Thus, although FIG. 5 illustrates separate transmissions of the RACH preamble and the PUSCH, the UE 115-d may transmit the RACH preamble and the PUSCH in a same RACH message.

At 510, the UE 115-d may transmit the RACH preamble in a RACH occasion. The RACH preamble in the RACH occasion may indicate a first beam for communications with the base station 105-d. That is, a first NBI may be indicated by the RACH preamble, the RACH occasion, or both. The RACH occasion may refer to time and frequency resources used to transmit the RACH preamble, and different RACH preambles (e.g., sequences), different RACH occasions, or different combinations of RACH preambles and RACH occasions may map to different beams. Thus, when the UE 115-d identifies the first beam (e.g., first new beam) for communications with the base station 105-d, the UE 115-d may transmit a RACH preamble in a RACH occasion that maps to the first beam. The base station 105-d may then receive the RACH preamble in the RACH occasion and determine that the RACH preamble in the RACH occasion maps to the first beam. Thus, the base station 105-d may determine that the UE 115-d has indicated the first beam for communications with the base station 105-d.

At 515, the UE 115-d may transmit, and the base station 105-d may receive, the PUSCH transmission. The PUSCH may include a control element (e.g., MAC-CE) indicating at least a second beam for communications with the base station 105-d. That is, the control element in the PUSCH may indicate one or more additional beams (e.g., remaining NBIs) for communications with the base station 105-d. In some cases, the first beam indicated by the RACH preamble in the RACH occasion at 510 may also be used for the PUSCH transmission. That is, the UE 115-d may transmit, and the base station 105-d may receive, the RACH preamble at 510 and the PUSCH transmission at 515 in the first RACH message using the first beam.

In some cases, in addition to indicating the first beam and the second beam to the base station 105-d, the UE 115-d may indicate a TRP panel associated with the first beam, a TRP panel associated with the second beam, or both. In such cases, the first beam may be associated with a first TRP panel and the second beam may be associated with a second TRP panel. In one example, the UE 115-d may transmit an indication of the second TRP panel associated with the second beam in the control element in the PUSCH at 515 (e.g., the same control element that carries the indication of the second beam). That is, the ID of the second TRP panel may be explicitly carried in the control element (e.g., MAC-CE). The base station 105-d may then schedule communications with the UE 115-d on a beam based at least in part on a TRP panel associated with the beam.

At 520, the base station 105-d may transmit a second RACH message to the UE 115-d including a RAR in response to the first RACH message from the UE 115-d. At 525, the UE 115-d and the base station 105-d may communicate using the first beam, the second beam, or both. For instance, after indicating the first beam and the second beam to the base station 105-d, the UE 115-d may monitor a PDCCH for control information from the base station 105-d using the first beam and the second beam to recover communications with the base station 105-d. That is, the UE 115-d may rely on multi-beam operation to recover communications with the base station 105-d.

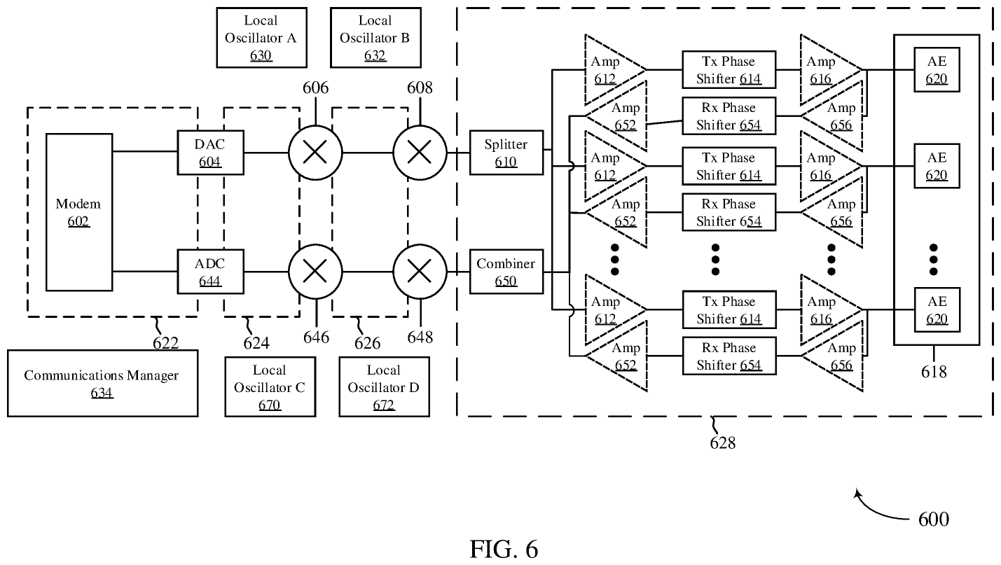

FIG. 6 illustrates an example of an architecture 600 that supports NBI reporting for multi-beam operation in accordance with aspects of the present disclosure. In some examples, architecture 600 may implement aspects of wireless communications system 100 and 200 and process flows 300, 400, and 500. In some aspects, diagram 600 may be an example of a receiving device (e.g., a UE 115 or a base station 105) and/or a transmitting device (e.g., a UE 115 or a base station 105), as described herein.

Broadly, FIG. 6 is a diagram illustrating example hardware components of a wireless device in accordance with certain aspects of the disclosure. The illustrated components may include those that may be used for antenna element selection and/or for beamforming for transmission of wireless signals. There are numerous architectures for antenna element selection and implementing phase shifting, only one example of which is illustrated here. The architecture 600 includes a modem (modulator/demodulator) 602, a digital to analog converter (DAC) 604, a first mixer 606, a second mixer 608, and a splitter 610. The architecture 600 also includes a plurality of first amplifiers 612, a plurality of phase shifters 614, a plurality of second amplifiers 616, and an antenna array 618 that includes a plurality of antenna elements 620. Transmission lines or other waveguides, wires, traces, or the like are shown connecting the various components to illustrate how signals to be transmitted may travel between components. Boxes 622, 624, 626, and 628 indicate regions in the architecture 600 in which different types of signals travel or are processed. Specifically, box 622 indicates a region in which digital baseband signals travel or are processed, box 624 indicates a region in which analog baseband signals travel or are processed, box 626 indicates a region in which analog intermediate frequency (IF) signals travel or are processed, and box 628 indicates a region in which analog radio frequency (RF) signals travel or are processed. The architecture also includes a local oscillator A 630, a local oscillator B 632, and a communications manager 634.

Each of the antenna elements 620 may include one or more sub-elements (not shown) for radiating or receiving RF signals. For example, a single antenna element 620 may include a first sub-element cross-polarized with a second sub-element that can be used to independently transmit cross-polarized signals. The antenna elements 620 may include patch antennas or other types of antennas arranged in a linear, two dimensional, or other pattern. A spacing between antenna elements 620 may be such that signals with a desired wavelength transmitted separately by the antenna elements 620 may interact or interfere (e.g., to form a desired beam). For example, given an expected range of wavelengths or frequencies, the spacing may provide a quarter wavelength, half wavelength, or other fraction of a wavelength of spacing between neighboring antenna elements 620 to allow for interaction or interference of signals transmitted by the separate antenna elements 620 within that expected range.

The modem 602 processes and generates digital baseband signals and may also control operation of the DAC 604, first and second mixers 606, 608, splitter 610, first amplifiers 612, phase shifters 614, and/or the second amplifiers 616 to transmit signals via one or more or all of the antenna elements 620. The modem 602 may process signals and control operation in accordance with a communication standard such as a wireless standard discussed herein. The DAC 604 may convert digital baseband signals received from the modem 602 (and that are to be transmitted) into analog baseband signals. The first mixer 606 upconverts analog baseband signals to analog IF signals within an IF using a local oscillator A 630. For example, the first mixer 606 may mix the signals with an oscillating signal generated by the local oscillator A 630 to “move” the baseband analog signals to the IF. In some cases some processing or filtering (not shown) may take place at the IF. The second mixer 608 upconverts the analog IF signals to analog RF signals using the local oscillator B 632. Similarly to the first mixer, the second mixer 608 may mix the signals with an oscillating signal generated by the local oscillator B 632 to “move” the IF analog signals to the RF, or the frequency at which signals will be transmitted or received. The modem 602 and/or the communications manager 634 may adjust the frequency of local oscillator A 630 and/or the local oscillator B 632 so that a desired IF and/or RF frequency is produced and used to facilitate processing and transmission of a signal within a desired bandwidth.

In the illustrated architecture 600, signals upconverted by the second mixer 608 are split or duplicated into multiple signals by the splitter 610. The splitter 610 in architecture 600 splits the RF signal into a plurality of identical or nearly identical RF signals, as denoted by its presence in box 628. In other embodiments, the split may take place with any type of signal including with baseband digital, baseband analog, or IF analog signals. Each of these signals may correspond to an antenna element 620 and the signal travels through and is processed by amplifiers 612, 616, phase shifters 614, and/or other elements corresponding to the respective antenna element 620 to be provided to and transmitted by the corresponding antenna element 620 of the antenna array 618. In one embodiment, the splitter 610 may be an active splitter that is connected to a power supply and provides some gain so that RF signals exiting the splitter 610 are at a power level equal to or greater than the signal entering the splitter 610. In another embodiment, the splitter 610 is a passive splitter that is not connected to a power supply and the RF signals exiting the splitter 610 may be at a power level lower than the RF signal entering the splitter 610.

After being split by the splitter 610, the resulting RF signals may enter an amplifier, such as a first amplifier 612, or a phase shifter 614 corresponding to an antenna element 620. The first and second amplifiers 612, 616 are illustrated with dashed lines because one or both of them might not be necessary in some implementations. In one implementation, both the first amplifier 612 and second amplifier 616 are present. In another, neither the first amplifier 612 nor the second amplifier 616 is present. In other implementations, one of the two amplifiers 612, 616 is present but not the other. By way of example, if the splitter 610 is an active splitter, the first amplifier 612 may not be used. By way of further example, if the phase shifter 614 is an active phase shifter that can provide a gain, the second amplifier 616 might not be used. The amplifiers 612, 616 may provide a desired level of positive or negative gain. A positive gain (positive dB) may be used to increase an amplitude of a signal for radiation by a specific antenna element 620. A negative gain (negative dB) may be used to decrease an amplitude and/or suppress radiation of the signal by a specific antenna element. Each of the amplifiers 612, 616 may be controlled independently (e.g., by the modem 602 or communications manager 634) to provide independent control of the gain for each antenna element 620. For example, the modem 602 and/or the communications manager 634 may have at least one control line connected to each of the splitter 610, first amplifiers 612, phase shifters 614, and/or second amplifiers 616 which may be used to configure a gain to provide a desired amount of gain for each component and thus each antenna element 620.

The phase shifter 614 may provide a configurable phase shift or phase offset to a corresponding RF signal to be transmitted. The phase shifter 614 could be a passive phase shifter not directly connected to a power supply. Passive phase shifters might introduce some insertion loss. The second amplifier 616 could boost the signal to compensate for the insertion loss. The phase shifter 614 could be an active phase shifter connected to a power supply such that the active phase shifter provides some amount of gain or prevents insertion loss. The settings of each of the phase shifters 614 are independent meaning that each can be set to provide a desired amount of phase shift or the same amount of phase shift or some other configuration. The modem 602 and/or the communications manager 634 may have at least one control line connected to each of the phase shifters 614 and which may be used to configure the phase shifters 614 to provide desired amounts of phase shift or phase offset between antenna elements 620.

The architecture 600 is given by way of example only to illustrate an architecture for transmitting and/or receiving signals. It will be understood that the architecture 600 and/or each portion of the architecture 600 may be repeated multiple times within an architecture to accommodate or provide an arbitrary number of RF chains, antenna elements, and/or antenna panels. Furthermore, numerous alternate architectures are possible and contemplated. For example, although only a single antenna array 618 is shown, two, three, or more antenna arrays may be included each with one or more of their own corresponding amplifiers, phase shifters, splitters, mixers, DACs, and/or modems. For example, a single UE may include two, four or more antenna arrays for transmitting or receiving signals at different physical locations on the UE or in different directions. Furthermore, mixers, splitters, amplifiers, phase shifters and other components may be located in different signal type areas (e.g., different ones of the boxes 622, 624, 626, 628) in different implemented architectures. For example, a split of the signal to be transmitted into a plurality of signals may take place at the analog RF, analog IF, analog baseband, or digital baseband frequencies in different embodiments. Similarly, amplification, and/or phase shifts may also take place at different frequencies. For example, in some contemplated implementations, one or more of the splitter 610, amplifiers 612, 616, or phase shifters 614 may be located between the DAC 604 and the first mixer 606 or between the first mixer 606 and the second mixer 608. In one embodiment, the functions of one or more of the components may be combined into one component. For example, the phase shifters 614 may perform amplification to include or replace the first and/or or second amplifiers 612, 616. By way of another example, a phase shift may be implemented by the second mixer 608 to obviate the need for a separate phase shifter 614.

This technique is sometimes called local oscillator (LO) phase shifting. In one implementation of this configuration, there may be a plurality of IF to RF mixers (e.g., for each antenna element chain) within the second mixer 608 and the local oscillator B 632 would supply different local oscillator signals (with different phase offsets) to each IF to RF mixer.

The modem 602 and/or the communications manager 634 may control one or more of the other components 604-620 to select one or more antenna elements 620 and/or to form beams for transmission of one or more signals. For example, the antenna elements 620 may be individually selected or deselected for transmission of a signal (or signals) by controlling an amplitude of one or more corresponding amplifiers, such as the first amplifiers 612 and/or the second amplifiers 616. Beamforming includes generation of a beam using a plurality of signals on different antenna elements where one or more or all of the plurality of signals are shifted in phase relative to each other. The formed beam may carry physical or higher layer reference signals or information. As each signal of the plurality of signals is radiated from a respective antenna element 620, the radiated signals interact, interfere (constructive and destructive interference), and amplify each other to form a resulting beam. The shape (such as the amplitude, width, and/or presence of side lobes) and the direction (such as an angle of the beam relative to a surface of the antenna array 618) can be dynamically controlled by modifying the phase shifts or phase offsets imparted by the phase shifters 614 and amplitudes imparted by the amplifiers 612, 616 of the plurality of signals relative to each other.

The communications manager 634 may, when architecture 600 is configured as a UE 115, transmit, to a base station 105, a random-access preamble in a random-access occasion indicating a first beam for communications with the base station based at least in part on detecting a beam failure. The communications manager 634 may transmit, to the base station, a control element in a data channel indicating a second beam for communications with the base station based at least in part on detecting the beam failure. The communications manager 634 may communicate with the base station using the first beam, the second beam, or both based at least in part on transmitting the random-access preamble indicating the first beam and the control element in the data channel indicating the second beam.

The communications manager 634 may, when architecture 600 is configured as a base station 105, may receive, from a UE 115, a random-access preamble in a random-access occasion indicating a first beam for communications with the UE based at least in part on a beam failure. The communications manager 634 may receive, from the UE, a control element in a data channel indicating a second beam for communications with the UE based at least in part on the beam failure. The communications manager 634 may communicate with the UE using the first beam, the second beam, or both based at least in part on receiving the random-access preamble indicating the first beam and the control element in the data channel indicating the second beam.

The communications manager 634 may be located partially or fully within one or more other components of the architecture 600. For example, the communications manager 634 may be located within the modem 602 in at least one implementation.

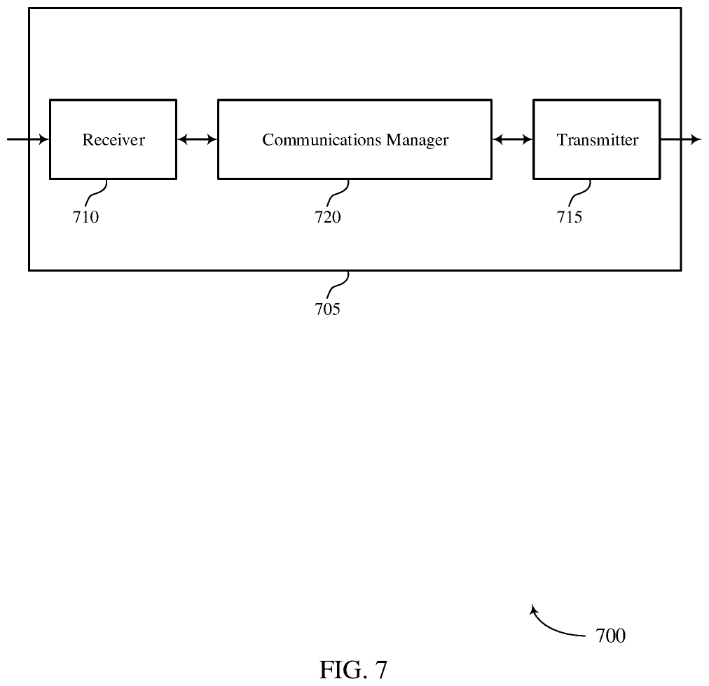

FIG. 7 shows a block diagram 700 of a device 705 that supports NBI reporting for multi-beam operation in accordance with aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to NBI reporting for multi-beam operation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to NBI reporting for multi-beam operation). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of NBI reporting for multi-beam operation as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a user equipment in accordance with examples as disclosed herein. For example, the communications manager 720 may be configured as or otherwise support a means for transmitting, to a base station, a random-access preamble in a random-access occasion indicating a first beam for communications with the base station based on detecting a beam failure. The communications manager 720 may be configured as or otherwise support a means for transmitting, to the base station, a control element in a data channel indicating a second beam for communications with the base station based on detecting the beam failure. The communications manager 720 may be configured as or otherwise support a means for communicating with the base station using the first beam, the second beam, or both based on transmitting the random-access preamble indicating the first beam and the control element in the data channel indicating the second beam.

By including or configuring the communications manager 720 in accordance with examples as described herein, the device 705 (e.g., a processor controlling or otherwise coupled to the receiver 710, the transmitter 715, the communications manager 720, or a combination thereof) may support techniques for reduced processing and reduced power consumption at a wireless device (e.g., a UE 115). In particular, the techniques described herein may allow a UE 115 to utilize multi-beam operation to recover communications with a base station 105. As a result, the UE 115 may be more likely to recover communications with the base station 105, and the UE 115 may avoid continuously attempting to re-establish a connection with the base station 105 or recover communications with the base station 105.

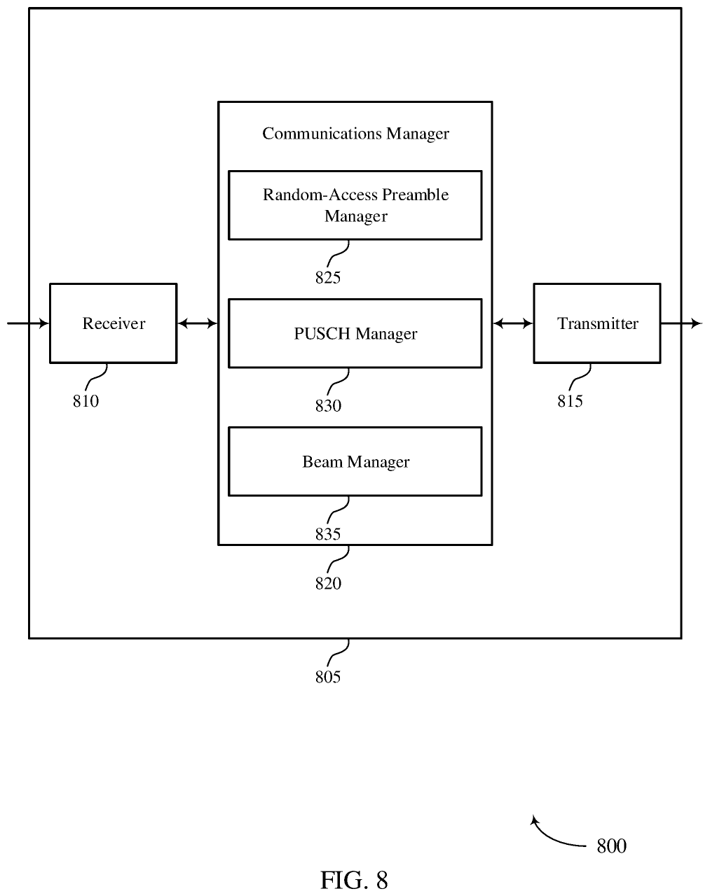

FIG. 8 shows a block diagram 800 of a device 805 that supports NBI reporting for multi-beam operation in accordance with aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to NBI reporting for multi-beam operation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to NBI reporting for multi-beam operation). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of NBI reporting for multi-beam operation as described herein. For example, the communications manager 820 may include a random-access preamble manager 825, an PUSCH manager 830, a beam manager 835, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a user equipment in accordance with examples as disclosed herein. The random-access preamble manager 825 may be configured as or otherwise support a means for transmitting, to a base station, a random-access preamble in a random-access occasion indicating a first beam for communications with the base station based on detecting a beam failure. The PUSCH manager 830 may be configured as or otherwise support a means for transmitting, to the base station, a control element in a data channel indicating a second beam for communications with the base station based on detecting the beam failure. The beam manager 835 may be configured as or otherwise support a means for communicating with the base station using the first beam, the second beam, or both based on transmitting the random-access preamble indicating the first beam and the control element in the data channel indicating the second beam.

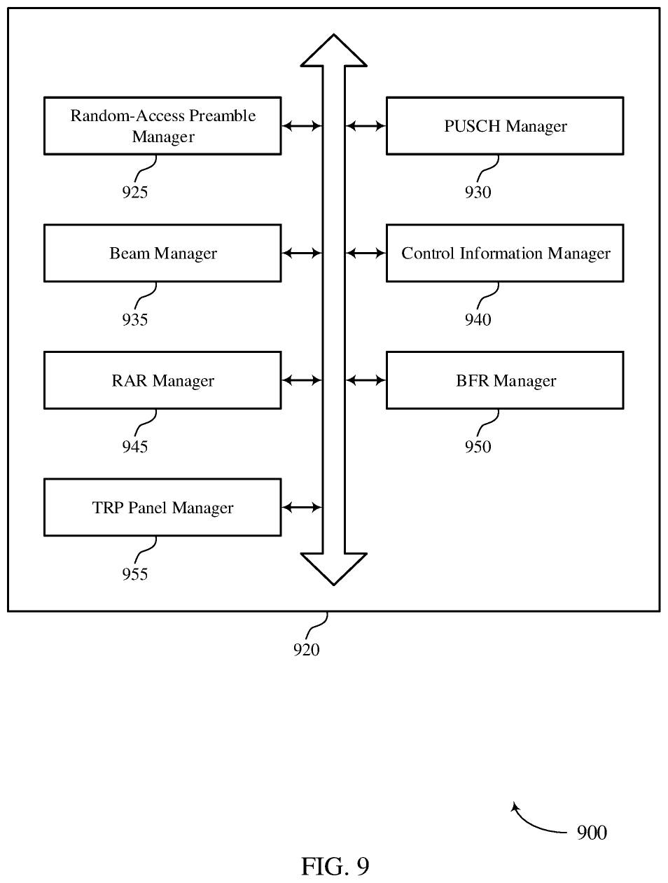

FIG. 9 shows a block diagram 900 of a communications manager 920 that supports NBI reporting for multi-beam operation in accordance with aspects of the present disclosure. The communications manager 920 may be an example of aspects of a communications manager 720, a communications manager 820, or both, as described herein. The communications manager 920, or various components thereof, may be an example of means for performing various aspects of NBI reporting for multi-beam operation as described herein. For example, the communications manager 920 may include a random-access preamble manager 925, an PUSCH manager 930, a beam manager 935, a control information manager 940, a RAR manager 945, an BFR manager 950, an TRP panel manager 955, or any combination thereof. Each of these components may communicate, directly or indirectly, with one another (e.g., via one or more buses).

The communications manager 920 may support wireless communication at a user equipment in accordance with examples as disclosed herein. The random-access preamble manager 925 may be configured as or otherwise support a means for transmitting, to a base station, a random-access preamble in a random-access occasion indicating a first beam for communications with the base station based on detecting a beam failure. The PUSCH manager 930 may be configured as or otherwise support a means for transmitting, to the base station, a control element in a data channel indicating a second beam for communications with the base station based on detecting the beam failure. The beam manager 935 may be configured as or otherwise support a means for communicating with the base station using the first beam, the second beam, or both based on transmitting the random-access preamble indicating the first beam and the control element in the data channel indicating the second beam.

In some examples, to support transmitting the random-access preamble indicating the first beam and the control element in the data channel indicating the second beam, the random-access preamble manager 925 may be configured as or otherwise support a means for transmitting the random-access preamble indicating the first beam in a first random-access message of a contention-based random-access procedure. In some examples, to support transmitting the random-access preamble indicating the first beam and the control element in the data channel indicating the second beam, the PUSCH manager 930 may be configured as or otherwise support a means for transmitting the control element in the data channel indicating the second beam in a third random-access message of the contention-based random-access procedure. In some examples, the RAR manager 945 may be configured as or otherwise support a means for receiving a random-access response in a second random-access message of the contention-based random-access procedure in response to transmitting the random-access preamble, where the random-access response includes downlink control information scheduling transmission in the data channel.

In some examples, to support transmitting the random-access preamble indicating the first beam, the random-access preamble manager 925 may be configured as or otherwise support a means for transmitting the random-access preamble indicating the first beam in a first random-access message of a contention-free random-access procedure. In some examples, the BFR manager 950 may be configured as or otherwise support a means for receiving a beam failure response in a second random-access message of the contention-free random-access procedure in response to transmitting the random-access preamble, where the beam failure response includes downlink control information scheduling transmission in the data channel.

In some examples, to support transmitting the random-access preamble indicating the first beam and the control element in the data channel indicating the second beam, the random-access preamble manager 925 may be configured as or otherwise support a means for transmitting the random-access preamble indicating the first beam and the control element in the data channel indicating the second beam in a first random-access message of a two-step random-access procedure.

In some examples, the first beam is associated with a first transmission and reception panel at the UE, and the second beam is associated with a second transmission and reception panel at the UE. In some examples, the TRP panel manager 955 may be configured as or otherwise support a means for transmitting, to the base station in the control element in the data channel, an indication of the second transmission and reception panel associated with the second beam.

In some examples, to support communicating with the base station using the first beam, the second beam, or both, the control information manager 940 may be configured as or otherwise support a means for receiving control information in a control channel from the base station using the first beam, the second beam, or both. In some examples, the control element in the data channel includes a channel state information reference signal resource index or a synchronization signal block index indicating the second beam for communications with the base station.

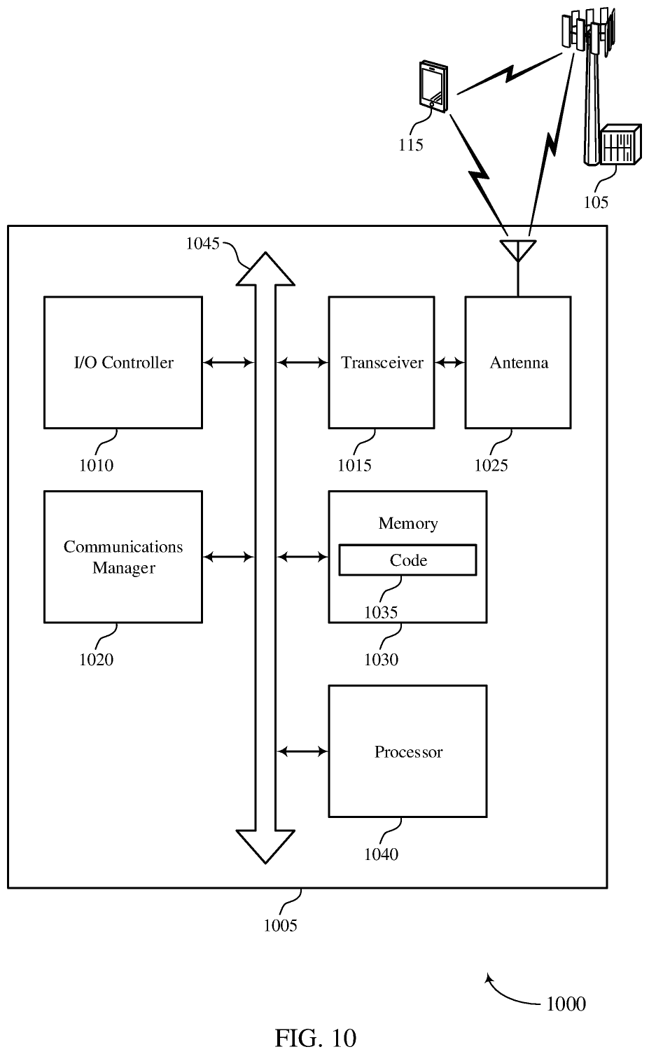

FIG. 10 shows a diagram of a system 1000 including a device 1005 that supports NBI reporting for multi-beam operation in accordance with aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting NBI reporting for multi-beam operation). For example, the device 1005 or a component of the device 1005 may include a processor 1040 and memory 1030 coupled to the processor 1040, the processor 1040 and memory 1030 configured to perform various functions described herein.

The communications manager 1020 may support wireless communication at a user equipment in accordance with examples as disclosed herein. For example, the communications manager 1020 may be configured as or otherwise support a means for transmitting, to a base station, a random-access preamble in a random-access occasion indicating a first beam for communications with the base station based on detecting a beam failure. The communications manager 1020 may be configured as or otherwise support a means for transmitting, to the base station, a control element in a data channel indicating a second beam for communications with the base station based on detecting the beam failure. The communications manager 1020 may be configured as or otherwise support a means for communicating with the base station using the first beam, the second beam, or both based on transmitting the random-access preamble indicating the first beam and the control element in the data channel indicating the second beam.

By including or configuring the communications manager 1020 in accordance with examples as described herein, the device 1005 may support techniques for reduced processing and reduced power consumption at a wireless device (e.g., a UE 115). In particular, the techniques described herein may allow a UE 115 to utilize multi-beam operation to recover communications with a base station 105. As a result, the UE 115 may be more likely to recover communications with the base station 105, and the UE 115 may avoid continuously attempting to re-establish a connection with the base station 105 or recover communications with the base station 105.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of NBI reporting for multi-beam operation as described herein, or the processor 1040 and the memory 1030 may be otherwise configured to perform or support such operations.

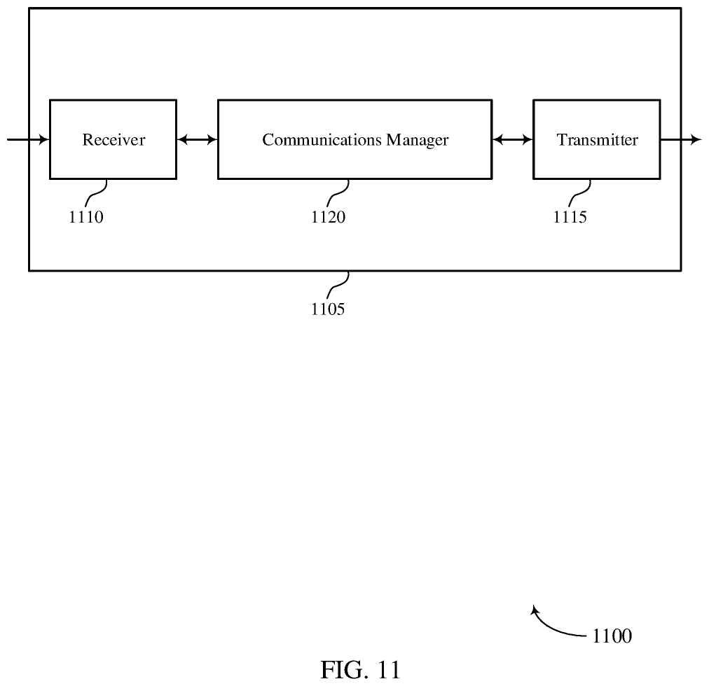

FIG. 11 shows a block diagram 1100 of a device 1105 that supports NBI reporting for multi-beam operation in accordance with aspects of the present disclosure. The device 1105 may be an example of aspects of a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to NBI reporting for multi-beam operation). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to NBI reporting for multi-beam operation). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of NBI reporting for multi-beam operation as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a base station in accordance with examples as disclosed herein. For example, the communications manager 1120 may be configured as or otherwise support a means for receiving, from a UE, a random-access preamble in a random-access occasion indicating a first beam for communications with the UE based on a beam failure. The communications manager 1120 may be configured as or otherwise support a means for receiving, from the UE, a control element in a data channel indicating a second beam for communications with the UE based on the beam failure. The communications manager 1120 may be configured as or otherwise support a means for communicating with the UE using the first beam, the second beam, or both based on receiving the random-access preamble indicating the first beam and the control element in the data channel indicating the second beam.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for reduced processing and reduced power consumption at a wireless device (e.g., a base station 105). In particular, the techniques described herein may allow a base station 105 to utilize multi-beam operation to recover communications with a UE 115. As a result, the base station 105 may be more likely to recover communications with the UE 115, and the base station 105 may avoid communicating with the UE 115 to re-establish a connection with the UE 115 or recover communications with the UE 115.

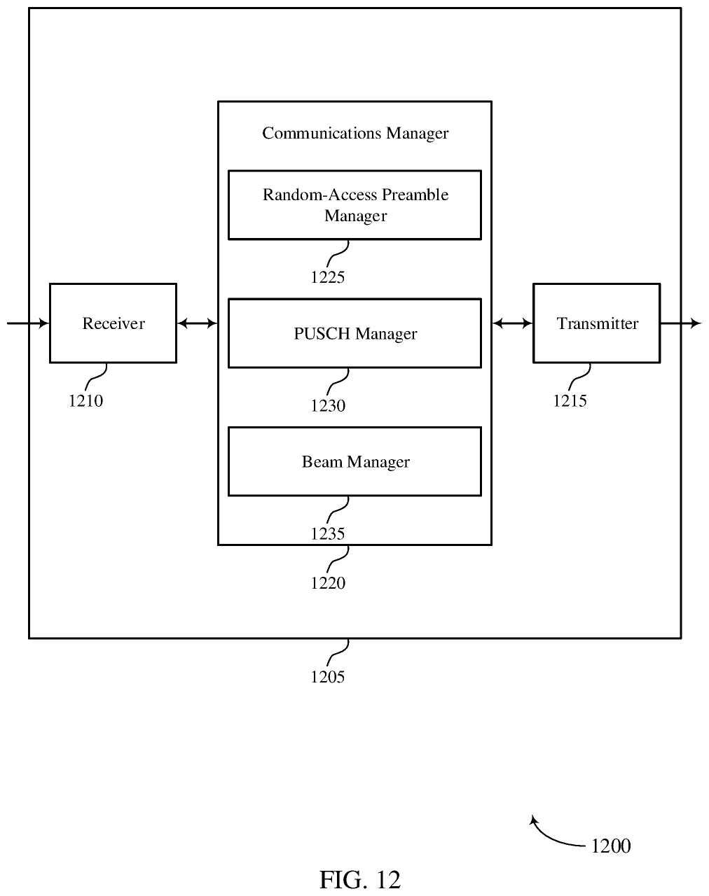

FIG. 12 shows a block diagram 1200 of a device 1205 that supports NBI reporting for multi-beam operation in accordance with aspects of the present disclosure. The device 1205 may be an example of aspects of a device 1105 or a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to NBI reporting for multi-beam operation). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to NBI reporting for multi-beam operation). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of NBI reporting for multi-beam operation as described herein.

For example, the communications manager 1220 may include a random-access preamble manager 1225, an PUSCH manager 1230, a beam manager 1235, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a base station in accordance with examples as disclosed herein. The random-access preamble manager 1225 may be configured as or otherwise support a means for receiving, from a UE, a random-access preamble in a random-access occasion indicating a first beam for communications with the UE based on a beam failure. The PUSCH manager 1230 may be configured as or otherwise support a means for receiving, from the UE, a control element in a data channel indicating a second beam for communications with the UE based on the beam failure. The beam manager 1235 may be configured as or otherwise support a means for communicating with the UE using the first beam, the second beam, or both based on receiving the random-access preamble indicating the first beam and the control element in the data channel indicating the second beam.

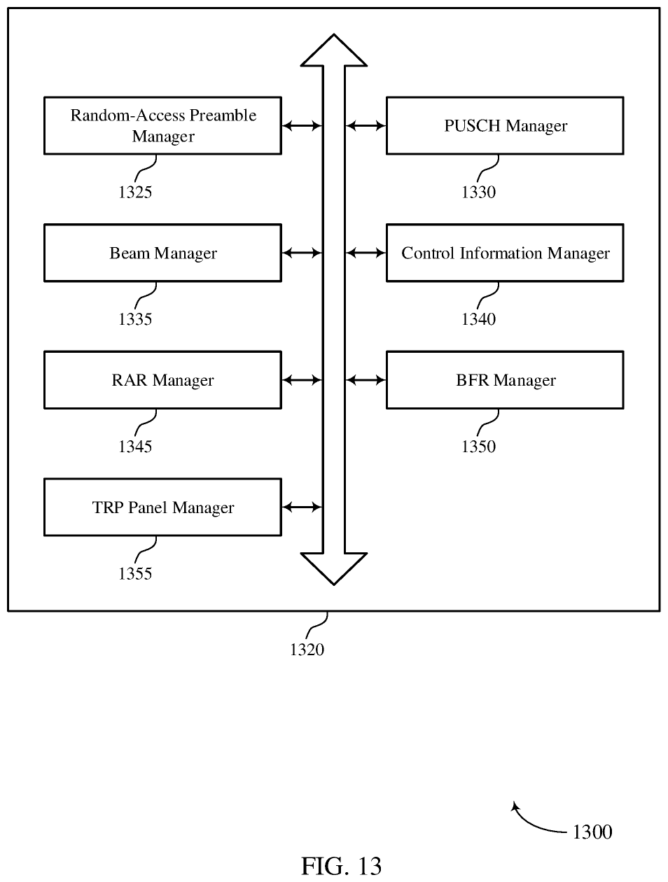

FIG. 13 shows a block diagram 1300 of a communications manager 1320 that supports NBI reporting for multi-beam operation in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of NBI reporting for multi-beam operation as described herein. For example, the communications manager 1320 may include a random-access preamble manager 1325, an PUSCH manager 1330, a beam manager 1335, a control information manager 1340, a RAR manager 1345, an BFR manager 1350, an TRP panel manager 1355, or any combination thereof. Each of these components may communicate, directly or indirectly, with one another (e.g., via one or more buses).

The communications manager 1320 may support wireless communication at a base station in accordance with examples as disclosed herein. The random-access preamble manager 1325 may be configured as or otherwise support a means for receiving, from a UE, a random-access preamble in a random-access occasion indicating a first beam for communications with the UE based on a beam failure. The PUSCH manager 1330 may be configured as or otherwise support a means for receiving, from the UE, a control element in a data channel indicating a second beam for communications with the UE based on the beam failure. The beam manager 1335 may be configured as or otherwise support a means for communicating with the UE using the first beam, the second beam, or both based on receiving the random-access preamble indicating the first beam and the control element in the data channel indicating the second beam.

In some examples, to support receiving the random-access preamble indicating the first beam and the control element in the data channel indicating the second beam, the random-access preamble manager 1325 may be configured as or otherwise support a means for receiving the random-access preamble indicating the first beam in a first random-access message of a contention-based random-access procedure. In some examples, to support receiving the random-access preamble indicating the first beam and the control element in the data channel indicating the second beam, the PUSCH manager 1330 may be configured as or otherwise support a means for receiving the control element in the data channel indicating the second beam in a third random-access message of the contention-based random-access procedure. In some examples, the RAR manager 1345 may be configured as or otherwise support a means for transmitting a random-access response in a second random-access message of the contention-based random-access procedure in response to receiving the random-access preamble, where the random-access response includes downlink control information scheduling transmission in the data channel.

In some examples, to support receiving the random-access preamble indicating the first beam, the random-access preamble manager 1325 may be configured as or otherwise support a means for receiving the random-access preamble indicating the first beam in a first random-access message of a contention-free random-access procedure. In some examples, the BFR manager 1350 may be configured as or otherwise support a means for transmitting a beam failure response in a second random-access message of the contention-free random-access procedure in response to receiving the random-access preamble, where the beam failure response includes downlink control information scheduling transmission in the data channel.

In some examples, to support receiving the random-access preamble indicating the first beam and the control element in the data channel indicating the second beam, the random-access preamble manager 1325 may be configured as or otherwise support a means for receiving the random-access preamble and the control element in the data channel in a first random-access message of a two-step random-access procedure.

In some examples, the first beam is associated with a first transmission and reception panel at the UE, and the second beam is associated with a second transmission and reception panel at the UE. In some examples, the TRP panel manager 1355 may be configured as or otherwise support a means for receiving, from the UE in the control element in the data channel, an indication of the second transmission and reception panel associated with the second beam.

In some examples, to support communicating with the UE using the first beam, the second beam, or both, the control information manager 1340 may be configured as or otherwise support a means for transmitting control information in a control channel to the UE using the first beam, the second beam, or both. In some examples, the control element in the data channel includes a channel state information reference signal resource index or a synchronization signal block index indicating the second beam for communications with the UE.

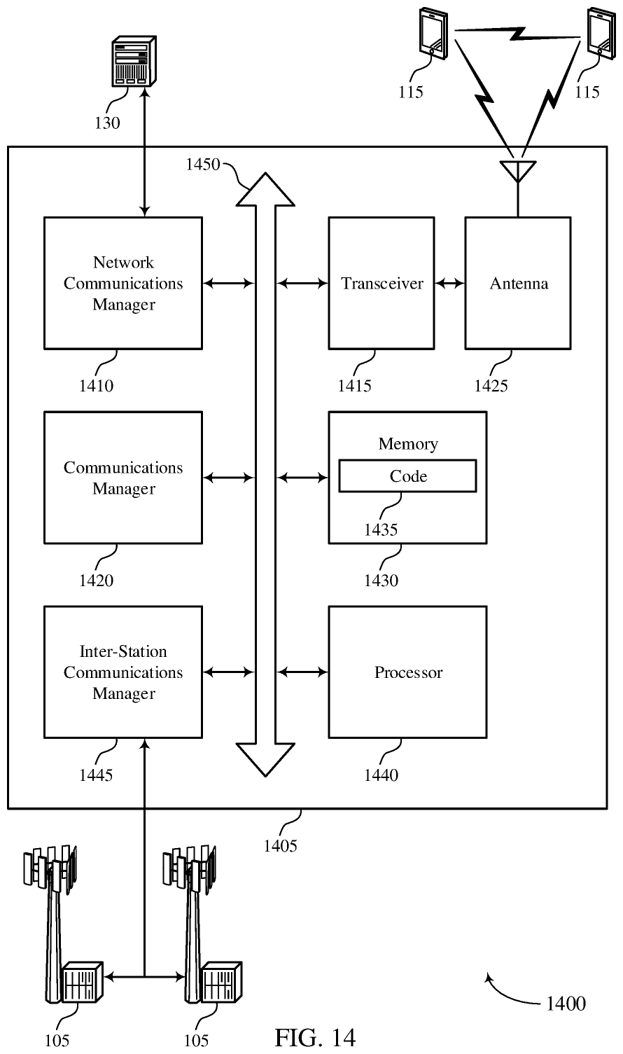

FIG. 14 shows a diagram of a system 1400 including a device 1405 that supports NBI reporting for multi-beam operation in accordance with aspects of the present disclosure. The device 1405 may be an example of or include the components of a device 1105, a device 1205, or a base station 105 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting NBI reporting for multi-beam operation). For example, the device 1405 or a component of the device 1405 may include a processor 1440 and memory 1430 coupled to the processor 1440, the processor 1440 and memory 1430 configured to perform various functions described herein.

The inter-station communications manager 1445 may manage communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communication at a base station in accordance with examples as disclosed herein. For example, the communications manager 1420 may be configured as or otherwise support a means for receiving, from a UE, a random-access preamble in a random-access occasion indicating a first beam for communications with the UE based on a beam failure. The communications manager 1420 may be configured as or otherwise support a means for receiving, from the UE, a control element in a data channel indicating a second beam for communications with the UE based on the beam failure. The communications manager 1420 may be configured as or otherwise support a means for communicating with the UE using the first beam, the second beam, or both based on receiving the random-access preamble indicating the first beam and the control element in the data channel indicating the second beam.

By including or configuring the communications manager 1420 in accordance with examples as described herein, the device 1405 may support techniques for reduced processing and reduced power consumption at a wireless device (e.g., a base station 105). In particular, the techniques described herein may allow a base station 105 to utilize multi-beam operation to recover communications with a UE 115. As a result, the base station 105 may be more likely to recover communications with the UE 115, and the base station 105 may avoid communicating with the UE 115 to re-establish a connection with the UE 115 or recover communications with the UE 115.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of NBI reporting for multi-beam operation as described herein, or the processor 1440 and the memory 1430 may be otherwise configured to perform or support such operations.

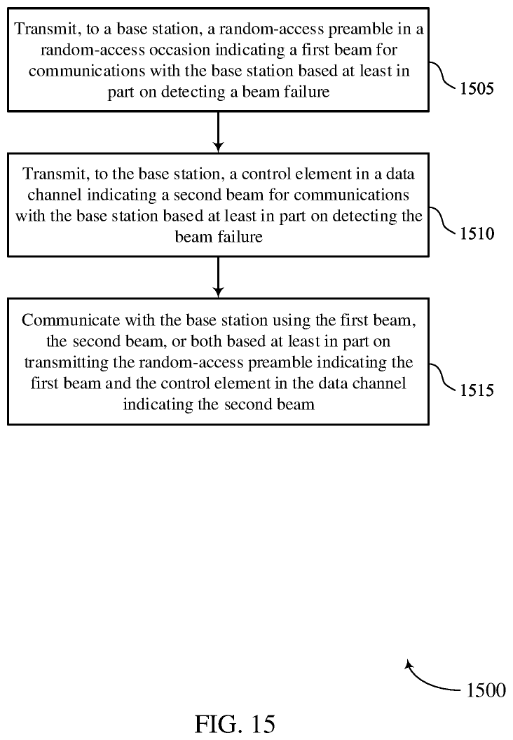

FIG. 15 shows a flowchart illustrating a method 1500 that supports NBI reporting for multi-beam operation in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting, to a base station, a random-access preamble in a random-access occasion indicating a first beam for communications with the base station based on detecting a beam failure. The operations of 1505 may be performed in accordance with examples as disclosed herein. In some examples, aspects of the operations of 1505 may be performed by a random-access preamble manager 925 as described with reference to FIG. 9.

At 1510, the method may include transmitting, to the base station, a control element in a data channel indicating a second beam for communications with the base station based on detecting the beam failure. The operations of 1510 may be performed in accordance with examples as disclosed herein. In some examples, aspects of the operations of 1510 may be performed by an PUSCH manager 930 as described with reference to FIG. 9.

At 1515, the method may include communicating with the base station using the first beam, the second beam, or both based on transmitting the random-access preamble indicating the first beam and the control element in the data channel indicating the second beam. The operations of 1515 may be performed in accordance with examples as disclosed herein. In some examples, aspects of the operations of 1515 may be performed by a beam manager 935 as described with reference to FIG. 9.

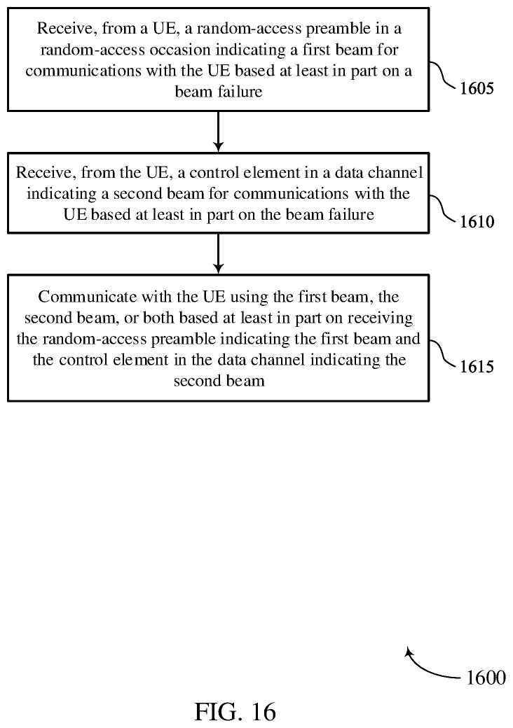

FIG. 16 shows a flowchart illustrating a method 1600 that supports NBI reporting for multi-beam operation in accordance with aspects of the present disclosure. The operations of the method 1600 may be implemented by a base station or its components as described herein. For example, the operations of the method 1600 may be performed by a base station 105 as described with reference to FIGS. 1 through 6 and 11 through 14. In some examples, a base station may execute a set of instructions to control the functional elements of the base station to perform the described functions. Additionally, or alternatively, the base station may perform aspects of the described functions using special-purpose hardware.

At 1605, the method may include receiving, from a UE, a random-access preamble in a random-access occasion indicating a first beam for communications with the UE based on a beam failure. The operations of 1605 may be performed in accordance with examples as disclosed herein. In some examples, aspects of the operations of 1605 may be performed by a random-access preamble manager 1325 as described with reference to FIG. 13.

At 1610, the method may include receiving, from the UE, a control element in a data channel indicating a second beam for communications with the UE based on the beam failure. The operations of 1610 may be performed in accordance with examples as disclosed herein. In some examples, aspects of the operations of 1610 may be performed by an PUSCH manager 1330 as described with reference to FIG. 13.

At 1615, the method may include communicating with the UE using the first beam, the second beam, or both based on receiving the random-access preamble indicating the first beam and the control element in the data channel indicating the second beam. The operations of 1615 may be performed in accordance with examples as disclosed herein. In some examples, aspects of the operations of 1615 may be performed by a beam manager 1335 as described with reference to FIG. 13.

The following provides an overview of aspects of the present disclosure:

Aspect 1: A method for wireless communication at a user equipment, comprising: transmitting, to a base station, a random-access preamble in a random-access occasion indicating a first beam for communications with the base station based at least in part on detecting a beam failure; transmitting, to the base station, a control element in a data channel indicating a second beam for communications with the base station based at least in part on detecting the beam failure; and communicating with the base station using the first beam, the second beam, or both based at least in part on transmitting the random-access preamble indicating the first beam and the control element in the data channel indicating the second beam.

Aspect 2: The method of aspect 1, wherein transmitting the random-access preamble indicating the first beam and the control element in the data channel indicating the second beam comprises: transmitting the random-access preamble indicating the first beam in a first random-access message of a contention-based random-access procedure; and transmitting the control element in the data channel indicating the second beam in a third random-access message of the contention-based random-access procedure.

Aspect 3: The method of aspect 2, further comprising: receiving a random-access response in a second random-access message of the contention-based random-access procedure in response to transmitting the random-access preamble, wherein the random-access response comprises downlink control information scheduling transmission in the data channel.

Aspect 4: The method of any of aspects 1 through 3, wherein transmitting the random-access preamble indicating the first beam comprises: transmitting the random-access preamble indicating the first beam in a first random-access message of a contention-free random-access procedure.

Aspect 5: The method of aspect 4, further comprising: receiving a beam failure response in a second random-access message of the contention-free random-access procedure in response to transmitting the random-access preamble, wherein the beam failure response comprises downlink control information scheduling transmission in the data channel.

Aspect 6: The method of any of aspects 1 through 5, wherein transmitting the random-access preamble indicating the first beam and the control element in the data channel indicating the second beam comprises: transmitting the random-access preamble indicating the first beam and the control element in the data channel indicating the second beam in a first random-access message of a two-step random-access procedure.

Aspect 7: The method of any of aspects 1 through 6, wherein the first beam is associated with a first transmission and reception panel at the UE, and the second beam is associated with a second transmission and reception panel at the UE.

Aspect 8: The method of aspect 7, further comprising: transmitting, to the base station in the control element in the data channel, an indication of the second transmission and reception panel associated with the second beam.

Aspect 9: The method of any of aspects 1 through 8, wherein communicating with the base station using the first beam, the second beam, or both comprises: receiving control information in a control channel from the base station using the first beam, the second beam, or both.

Aspect 10: The method of any of aspects 1 through 9, wherein the control element in the data channel comprises a channel state information reference signal resource index or a synchronization signal block index indicating the second beam for communications with the base station.

Aspect 11: A method for wireless communication at a base station, comprising: receiving, from a UE, a random-access preamble in a random-access occasion indicating a first beam for communications with the UE based at least in part on a beam failure; receiving, from the UE, a control element in a data channel indicating a second beam for communications with the UE based at least in part on the beam failure; and communicating with the UE using the first beam, the second beam, or both based at least in part on receiving the random-access preamble indicating the first beam and the control element in the data channel indicating the second beam.

Aspect 12: The method of aspect 11, wherein receiving the random-access preamble indicating the first beam and the control element in the data channel indicating the second beam comprises: receiving the random-access preamble indicating the first beam in a first random-access message of a contention-based random-access procedure; and receiving the control element in the data channel indicating the second beam in a third random-access message of the contention-based random-access procedure.

Aspect 13: The method of aspect 12, further comprising: transmitting a random-access response in a second random-access message of the contention-based random-access procedure in response to receiving the random-access preamble, wherein the random-access response comprises downlink control information scheduling transmission in the data channel.

Aspect 14: The method of any of aspects 11 through 13, wherein receiving the random-access preamble indicating the first beam comprises: receiving the random-access preamble indicating the first beam in a first random-access message of a contention-free random-access procedure.

Aspect 15: The method of aspect 14, further comprising: transmitting a beam failure response in a second random-access message of the contention-free random-access procedure in response to receiving the random-access preamble, wherein the beam failure response comprises downlink control information scheduling transmission in the data channel.

Aspect 16: The method of any of aspects 11 through 15, wherein receiving the random-access preamble indicating the first beam and the control element in the data channel indicating the second beam comprises: receiving the random-access preamble and the control element in the data channel in a first random-access message of a two-step random-access procedure.

Aspect 17: The method of any of aspects 11 through 16, wherein the first beam is associated with a first transmission and reception panel at the UE, and the second beam is associated with a second transmission and reception panel at the UE.

Aspect 18: The method of aspect 17, further comprising: receiving, from the UE in the control element in the data channel, an indication of the second transmission and reception panel associated with the second beam.

Aspect 19: The method of any of aspects 11 through 18, wherein communicating with the UE using the first beam, the second beam, or both comprises: transmitting control information in a control channel to the UE using the first beam, the second beam, or both.

Aspect 20: The method of any of aspects 11 through 19, wherein the control element in the data channel comprises a channel state information reference signal resource index or a synchronization signal block index indicating the second beam for communications with the UE.

Aspect 21: An apparatus for wireless communication at a user equipment, comprising a processor; memory coupled with the processor; and instructions stored in the memory and executable by the processor to cause the apparatus to perform a method of any of aspects 1 through 10.

Aspect 22: An apparatus for wireless communication at a user equipment, comprising at least one means for performing a method of any of aspects 1 through 10.

Aspect 23: A non-transitory computer-readable medium storing code for wireless communication at a user equipment, the code comprising instructions executable by a processor to perform a method of any of aspects 1 through 10.

Aspect 24: An apparatus for wireless communication at a base station, comprising a processor; memory coupled with the processor; and instructions stored in the memory and executable by the processor to cause the apparatus to perform a method of any of aspects 11 through 20.

Aspect 25: An apparatus for wireless communication at a base station, comprising at least one means for performing a method of any of aspects 11 through 20.

Aspect 26: A non-transitory computer-readable medium storing code for wireless communication at a base station, the code comprising instructions executable by a processor to perform a method of any of aspects 11 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment, comprising:
transmitting, to a base station, a random-access preamble in a random-access occasion indicating a first beam for communications with the base station based at least in part on detecting a beam failure;
transmitting, to the base station, a control element in a data channel indicating a second beam for communications with the base station based at least in part on detecting the beam failure; and
communicating with the base station using the first beam, the second beam, or both based at least in part on transmitting the random-access preamble indicating the first beam and the control element in the data channel indicating the second beam.

2. The method of claim 1, wherein transmitting the random-access preamble indicating the first beam and the control element in the data channel indicating the second beam comprises:
transmitting the random-access preamble indicating the first beam in a first random-access message of a contention-based random-access procedure; and
transmitting the control element in the data channel indicating the second beam in a third random-access message of the contention-based random-access procedure.

3. The method of claim 2, further comprising:
receiving a random-access response in a second random-access message of the contention-based random-access procedure in response to transmitting the random-access preamble, wherein the random-access response comprises downlink control information scheduling transmission in the data channel.

4. The method of claim 1, wherein transmitting the random-access preamble indicating the first beam comprises:
transmitting the random-access preamble indicating the first beam in a first random-access message of a contention-free random-access procedure.

5. The method of claim 4, further comprising:
receiving a beam failure response in a second random-access message of the contention-free random-access procedure in response to transmitting the random-access preamble, wherein the beam failure response comprises downlink control information scheduling transmission in the data channel.

6. The method of claim 1, wherein transmitting the random-access preamble indicating the first beam and the control element in the data channel indicating the second beam comprises:
transmitting the random-access preamble indicating the first beam and the control element in the data channel indicating the second beam in a first random-access message of a two-step random-access procedure.

7. The method of claim 1, wherein the first beam is associated with a first transmission and reception panel at the UE, and the second beam is associated with a second transmission and reception panel at the UE.

8. The method of claim 7, further comprising:
transmitting, to the base station in the control element in the data channel, an indication of the second transmission and reception panel associated with the second beam.

9. The method of claim 1, wherein communicating with the base station using the first beam, the second beam, or both comprises:
receiving control information in a control channel from the base station using the first beam, the second beam, or both.

10. The method of claim 1, wherein the control element in the data channel comprises a channel state information reference signal resource index or a synchronization signal block index indicating the second beam for communications with the base station.

11. A method for wireless communication at a base station, comprising:
receiving, from a user equipment (UE), a random-access preamble in a random-access occasion indicating a first beam for communications with the UE based at least in part on a beam failure;
receiving, from the UE, a control element in a data channel indicating a second beam for communications with the UE based at least in part on the beam failure; and
communicating with the UE using the first beam, the second beam, or both based at least in part on receiving the random-access preamble indicating the first beam and the control element in the data channel indicating the second beam.

12. The method of claim 11, wherein receiving the random-access preamble indicating the first beam and the control element in the data channel indicating the second beam comprises:
receiving the random-access preamble indicating the first beam in a first random-access message of a contention-based random-access procedure; and
receiving the control element in the data channel indicating the second beam in a third random-access message of the contention-based random-access procedure.

13. The method of claim 12, further comprising:
transmitting a random-access response in a second random-access message of the contention-based random-access procedure in response to receiving the random-access preamble, wherein the random-access response comprises downlink control information scheduling transmission in the data channel.

14. The method of claim 11, wherein receiving the random-access preamble indicating the first beam comprises:
receiving the random-access preamble indicating the first beam in a first random-access message of a contention-free random-access procedure.

15. The method of claim 14, further comprising:
transmitting a beam failure response in a second random-access message of the contention-free random-access procedure in response to receiving the random-access preamble, wherein the beam failure response comprises downlink control information scheduling transmission in the data channel.

16. The method of claim 11, wherein receiving the random-access preamble indicating the first beam and the control element in the data channel indicating the second beam comprises:
receiving the random-access preamble and the control element in the data channel in a first random-access message of a two-step random-access procedure.

17. The method of claim 11, wherein the first beam is associated with a first transmission and reception panel at the UE, and the second beam is associated with a second transmission and reception panel at the UE.

18. The method of claim 17, further comprising:
receiving, from the UE in the control element in the data channel, an indication of the second transmission and reception panel associated with the second beam.

19. The method of claim 11, wherein communicating with the UE using the first beam, the second beam, or both comprises:
transmitting control information in a control channel to the UE using the first beam, the second beam, or both.

20. The method of claim 11, wherein the control element in the data channel comprises a channel state information reference signal resource index or a synchronization signal block index indicating the second beam for communications with the UE.

21. An apparatus for wireless communication at a user equipment, comprising:
a processor;
memory coupled with the processor; and
instructions stored in the memory and executable by the processor to cause the apparatus to:
transmit, to a base station, a random-access preamble in a random-access occasion indicating a first beam for communications with the base station based at least in part on detecting a beam failure;
transmit, to the base station, a control element in a data channel indicating a second beam for communications with the base station based at least in part on detecting the beam failure; and
communicate with the base station using the first beam, the second beam, or both based at least in part on transmitting the random-access preamble indicating the first beam and the control element in the data channel indicating the second beam.

22. The apparatus of claim 21, wherein the instructions to transmit the random-access preamble indicating the first beam and the control element in the data channel indicating the second beam are executable by the processor to cause the apparatus to:
transmit the random-access preamble indicating the first beam in a first random-access message of a contention-based random-access procedure; and
transmit the control element in the data channel indicating the second beam in a third random-access message of the contention-based random-access procedure.

23. The apparatus of claim 21, wherein the instructions to transmit the random-access preamble indicating the first beam are executable by the processor to cause the apparatus to:
transmit the random-access preamble indicating the first beam in a first random-access message of a contention-free random-access procedure.

24. The apparatus of claim 21, wherein the instructions to transmit the random-access preamble indicating the first beam and the control element in the data channel indicating the second beam are executable by the processor to cause the apparatus to:
transmit the random-access preamble indicating the first beam and the control element in the data channel indicating the second beam in a first random-access message of a two-step random-access procedure.

25. The apparatus of claim 21, wherein the instructions are further executable by the processor to cause the apparatus to:
transmit, to the base station in the control element in the data channel, an indication of a second transmission and reception panel associated with the second beam.

26. An apparatus for wireless communication at a base station, comprising:
a processor;
memory coupled with the processor; and
instructions stored in the memory and executable by the processor to cause the apparatus to:
receive, from a user equipment (UE), a random-access preamble in a random-access occasion indicating a first beam for communications with the UE based at least in part on a beam failure;
receive, from the UE, a control element in a data channel indicating a second beam for communications with the UE based at least in part on the beam failure; and
communicate with the UE using the first beam, the second beam, or both based at least in part on receiving the random-access preamble indicating the first beam and the control element in the data channel indicating the second beam.

27. The apparatus of claim 26, wherein the instructions to receive the random-access preamble indicating the first beam and the control element in the data channel indicating the second beam are executable by the processor to cause the apparatus to:
receive the random-access preamble indicating the first beam in a first random-access message of a contention-based random-access procedure; and
receive the control element in the data channel indicating the second beam in a third random-access message of the contention-based random-access procedure.

28. The apparatus of claim 26, wherein the instructions to receive the random-access preamble indicating the first beam are executable by the processor to cause the apparatus to:
receive the random-access preamble indicating the first beam in a first random-access message of a contention-free random-access procedure.

29. The apparatus of claim 26, wherein the instructions to receive the random-access preamble indicating the first beam and the control element in the data channel indicating the second beam are executable by the processor to cause the apparatus to:
receive the random-access preamble and the control element in the data channel in a first random-access message of a two-step random-access procedure.

30. The apparatus of claim 26, wherein the instructions are further executable by the processor to cause the apparatus to:
receive, from the UE in the control element in the data channel, an indication of a second transmission and reception panel associated with the second beam.
